(19) United States
(12) Patent Application Publication
(10) Pub. No.: US 2020/0367567 A1
(43) Pub. Date: Nov. 26, 2020

(54) PROMPTING METHOD AND APPARATUS, AND ELECTRONIC CIGARETTE

(71) Applicant: Changzhou Patent Electronic Technology Co., LTD., Changzhou City, Jiangsu Province (CN)

(72) Inventors: WEIHUA QIU, Changzhou City, Jiangsu Province (CN); NENG HUA, Changzhou City, Jiangsu Province (CN); GUIMEI FAN, Changzhou City, Jiangsu Province (CN)

(21) Appl. No.: 16/957,718

(22) PCT Filed: Nov. 23, 2018
(86) PCT No.: PCT/CN2018/117145

§ 371 Date: Jun. 24, 2020

(30) Foreign Application Priority Data
Dec. 25, 2017 (CN) 201711424310.6

(51) Int. Cl. A24F 40/53; A24F 40/60; A24F 40/10; G08B 21/02

(52) U.S. Cl. CPC A24F 40/53; A24F 40/60; G08B 5/36; G08B 21/02; A24F 40/10

(57) ABSTRACT

A prompting method and prompting apparatus for an atomizer, and an electronic cigarette. The prompting method includes: starting timing when it is detected that liquid is injected into an atomizer; according to timing information, determining whether a replacement condition for an object to be replaced is satisfied, wherein the object to be replaced includes at least one of the liquid and the atomizer; and when the replacement condition for the object to be replaced is satisfied, issuing a prompt information for prompting replacement of the object to be replaced. The prompting method can prompt, in a timely manner, a user to replace a damaged atomizer component and a damaged atomizer.

### TECHNICAL FIELD

The present invention relates to the technical field of atomizers, and in particular, to a prompting method and apparatus, and an electronic cigarette.

### BACKGROUND

An electronic cigarette is an electronic product that simulates tobacco cigarettes. The atomizer in the electronic cigarette can generate smoke by atomizing the cigarette liquid, and the smoke can be sucked into the body by the user of the electronic cigarette from the mouthpiece, thereby achieving the purpose of simulating smoking.

After the atomizer is put into use, the components in the atomizer will be worn out. At present, it is usually up to the user to determine subjectively whether the atomizer or the components in the atomizer need to be replaced, and the judgment result is prone to errors. If the components in the atomizer have been worn out and are not suitable for use, and the user continues to use the atomizer without knowing this, it will easily cause poor suction experience for the user and even endanger the user's physical health.

### SUMMARY

In order to solve the problem in the related art that the judgment result obtained by the user's subjective judgment on whether the atomizer or the components of the atomizer need to be replaced is prone to errors, embodiments of the present invention provide a prompting method and apparatus, and an electronic cigarette. The technical solution is as follows:

In a first aspect, a prompting method is provided. The prompting method includes:

starting timing when it is detected that liquid is injected into an atomizer;

determining whether a replacement condition for an object to be replaced is satisfied according to the timing information, wherein the object to be replaced includes at least one of the liquid and the atomizer;

when the replacement condition for the object to be replaced is satisfied, issuing a prompt information for prompting replacement of the object to be replaced.

Optionally, determining whether a replacement condition for an object to be replaced is satisfied according to the timing information includes:

obtaining a first timing length, wherein the first timing length is the length of time from the time when the atomizer is filled with liquid for the first time to the current time;

when the first timing length reaches a preset first time length, determining that the replacement condition for the atomizer is satisfied.

Optionally, determining whether a replacement condition for an object to be replaced is satisfied according to the timing information includes:

obtaining a second timing length, wherein the second timing length is the length of time from the last time the atomizer was injected with liquid to the current time;

when the second timing length reaches a preset second time length, obtaining a liquid level value of the liquid in the atomizer detected by a liquid level detector;

when the liquid level value of the liquid is higher than a minimum liquid level value, determining that the replacement condition for the liquid is satisfied.

Optionally, starting timing when it is detected that liquid is injected into an atomizer includes:

when the liquid level detector detects that the liquid level of the liquid in the atomizer increases, determining whether the atomizer is in the liquid filling state according to the posture of the atomizer;

when the atomizer is in the liquid filling state, starting timing to get the second timing length.

Optionally, the prompting method further includes:

when receiving a trigger instruction for triggering the operation of the atomizer, determining whether a first timing length is less than a preset third time length, wherein the first timing length is the length of time from the time when the atomizer is filled with liquid for the first time to the current time;

when the first timing length is less than the preset third time length, controlling the atomizer not to operate according to the trigger instruction.

Optionally, the prompting method further includes:

counting the number of working times or the cumulative working time of the atomizer;

when the number of working times reaches predetermined times, determining that the replacement condition for the atomizer is satisfied;

when the accumulated working time reaches a preset fourth time length, determining that the replacement condition for the atomizer is satisfied.

Optionally, counting the number of working times or the cumulative working time of the atomizer includes:

obtaining the device identifier of the atomizer in the electronic cigarette;

updating the number of working times or the accumulated working time of the atomizer according to the device identifier and the change of the working state of the atomizer.

In a second aspect, a prompting apparatus is provided, the prompting apparatus includes:

a memory and a processor;

at least one program instruction stored in the memory;

wherein the processor, by loading and executing the at least one program instruction, implements the prompting method according to the first aspect.

In a third aspect, an electronic cigarette is provided. The electronic cigarette includes the prompting apparatus according to the second aspect.

In a fourth aspect, an atomizer is provided. The atomizer includes the prompting apparatus according to the second aspect.

Optionally, the atomizer includes at least one of a timer and a power supply assembly.

The beneficial effects brought by the technical solutions provided by the embodiments of the present invention are:

The method starts timing when it is detected that the atomizer is filled with liquid; according to the timing information, it is determined whether the replacement condition for the object to be replaced is satisfied, wherein the object to be replaced includes at least one of the liquid and the atomizer; when the replacement condition for the object to be replaced is satisfied, a prompt information for prompting replacement of the object to be replaced is issued. It solves the problem in the related art that the judgment result by the user's subjective judgment on whether the atomizer or the components of the atomizer need to be replaced is prone to errors, and achieves the effect of timely prompting the user to replace the damaged components of the atomizer or the damaged atomizer.

### BRIEF DESCRIPTION OF THE DRAWINGS

In order to more clearly explain the technical solutions in the embodiments of the present invention, the drawings required in the description of the embodiments will be briefly introduced below. Obviously, the drawings in the following description are only some embodiments of the present invention. For those of ordinary skill in the art, without paying any creative work, other drawings can be obtained based on these drawings.

FIG. 1 is a flowchart of a prompting method according to an embodiment of the present invention;

FIG. 2 is a flowchart of determining whether the replacement condition for the atomizer is satisfied according to the first timing length according to an embodiment of the present invention;

FIG. 3 is a flowchart of determining whether the liquid replacement condition is satisfied according to the second timing length according to an embodiment of the present invention;

FIG. 4 is a schematic structural view of an atomizer according to an embodiment of the present invention.

Table 1 shows the names and labels of multiple components in FIG. 4 as follows:

| | |
|---|---|
| liquid level detector 41 | first contact 42 |
| processor 43 | power supply assembly 44 |
| second contact 45 | |

### DETAILED DESCRIPTION OF PREFERRED EMBODIMENTS

In order to make the objectives, technical solutions, and advantages of the present invention clearer, the following describes the embodiments of the present invention in further detail with reference to the accompanying drawings.

Before describing the embodiments of the present invention in detail, a brief description of the atomizer involved in the embodiments of the present invention is provided firstly: the atomizer includes an atomizing head and a liquid storage element, the atomizing head includes a liquid absorbing element and a heating element, and the heating element is used for atomizing the liquid absorbed by the liquid absorbing element from the liquid storage element. The liquid absorbing element mentioned here may be a cotton core, and the heating element may be a heating wire, a heating sheet or a ceramic sheet. The atomizer according to the embodiment of the present invention is further provided with a liquid level detector, which is used to detect the liquid level of the liquid in the liquid storage element.

Further, when the prompting method provided by the present invention is applied to an electronic cigarette or an atomizer in the electronic cigarette, the liquid involved in the embodiment of the present invention may be a cigarette liquid.

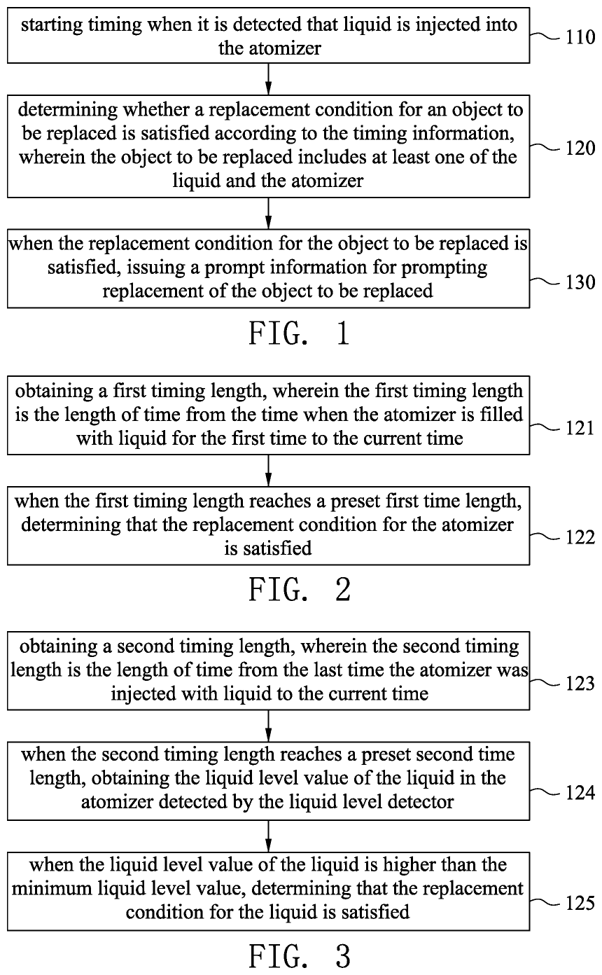

Referring to FIG. 1, it shows a flowchart of a prompting method according to an embodiment of the present invention. The prompting method can be applied to an electronic cigarette or an atomizer in the electronic cigarette. The prompting method may include the following steps:

Step 110: starting timing when it is detected that liquid is injected into the atomizer.

This step can be achieved by the following two implementation manners:

The first manner is to start timing when the atomizer is filled with liquid for the first time, and the length of time obtained by the timing is the first timing length T1. The specific implementation may be: when the liquid level detector detects that the liquid level in the atomizer reaches the minimum liquid level value for the first time, the timing starts, and the length of time obtained by the timing is the first timing length T1. The minimum liquid level value is usually set by the system developer.

Before the atomizer is put into use, the user needs to inject liquid into the liquid storage element in the atomizer to ensure that the liquid in the liquid storage element can be atomized when the atomizer is in operation. For example, after installing a brand-new atomizer to the body of the electronic cigarette, the user further needs to inject the cigarette liquid into the liquid storage element of the atomizer, so that the atomizer in the electronic cigarette can be used to atomize the cigarette liquid, so as to achieve the purpose of simulating smoking.

In this embodiment, when the liquid level detector detects that the liquid level in the atomizer reaches the minimum liquid level value for the first time, timing starts and T1 is obtained, and then T1 can be regarded as the length of time that the liquid absorbing element in the atomizer is soaked, or be regarded as the length of time the liquid absorbing element is put into use, or be regarded as the length of time the atomizer is put into use.

It should be noted that, when the liquid level detector detects that the liquid level in the atomizer reaches the minimum liquid level value for the first time, a first timer can be controlled to start timing to get the first timing length, or it can get the first timing length through software program, which is not specifically limited in this embodiment.

The second manner is to start timing when the atomizer is filled with liquid, and the length of time obtained by the timing is the second timing length T2. That is, the second timing length T2 is the length of time from the last time the atomizer was injected with liquid to the current time. T2 is the duration after the most recent injection of liquid, i.e., the use time after the most recent injection of liquid.

The specific implementation may be: when the liquid level detector detects that the liquid level of the liquid in the atomizer increases, the atomizer is determined whether it is in the liquid filling state according to the posture of the atomizer; when the atomizer is in the liquid filling state, it starts timing to get the second timing length.

Since the liquid filling into the atomizer by the user and the posture change of the atomizer both may increase the liquid level of the liquid in the atomizer, when it is detected by the liquid level detector that the liquid level of the liquid in the atomizer increases, it is necessary to determine whether the atomizer is in the liquid filling state according to the posture of the atomizer; when it is determined that the atomizer is in the liquid filling state, the timing is started to obtain the second timing length.

The implementation of obtaining the posture of the atomizer may be: the electronic device is provided with a gyroscope used for determining the posture of the electronic device according to the information collected by the gyroscope of the electronic device, so that the posture of the atomizer is determined according to the posture of the electronic device. Of course, in actual implementation, the atomizer itself may be provided with a gyroscope and a power supply assembly that supplies power to the gyroscope, so that the posture of the atomizer can be determined according to the information collected by the gyroscope of the atomizer.

The specific implementation of the second manner may also be: when the liquid level detector detects that the liquid level in the atomizer reaches a predetermined liquid level value, the timing starts, and the length of time obtained by the timing is the second timing length T2. The predetermined liquid level value is close to or equal to the maximum liquid level value of the atomizer.

Ordinary, when the liquid in the atomizer is exhausted or the amount of liquid is small, the user will inject a large amount of liquid into the liquid storage element, so that the liquid level of the liquid in the liquid storage element reaches or exceeds the predetermined liquid level value. In this case, when the liquid level detector detects that the liquid level in the atomizer reaches the predetermined liquid level value, timing starts and T2 is obtained. T2 is the duration after this injection of liquid, i.e., the use time after this injection of liquid.

It should be noted that, when the liquid level detector detects that the liquid level in the atomizer reaches the predetermined liquid level value, it starts timing. A second timer can be controlled to start timing to get the second timing length after clearing, or it can also get the second timing length through software program, which is not specifically limited in this embodiment.

Step 120: determining whether a replacement condition for an object to be replaced is satisfied according to the timing information, wherein the object to be replaced includes at least one of the liquid and the atomizer.

As shown in FIG. 2, step 120 can be implemented by the following steps:

Step 121: obtaining a first timing length, wherein the first timing length is the length of time from the time when the atomizer is filled with liquid for the first time to the current time.

Step 122: when the first timing length reaches a preset first time length, determining that the replacement condition for the atomizer is satisfied.

After the first timing length T1 reaches the preset first time length, it is considered that the liquid absorbing element (e.g., cotton core) in the atomizer is soaked for too long, resulting in that the liquid absorbing element in the atomizer is no longer usable, and thus it is determined that the replacement condition for the atomizer is satisfied.

The preset first time length can be set by the system developer or the user. For example, the system developer can determine the soaking time the liquid absorbing element is soaked to be damaged through experiments, and set the soaking time as the preset first time length.

It should be noted that, if the atomizing head in the atomizer is detachable and when the first timing length reaches the preset first time length, it can also be determined that the replacement condition for the atomizing head is satisfied, and the user is prompted to replace the atomizing head in the atomizer; if the liquid absorbing element in the atomizer is detachable and when the first timing length reaches the preset first time length, it can also be determined that the replacement condition for the liquid absorbing element is satisfied, and the user is prompted to replace the liquid absorbing element in the atomizer; if the atomizing head and the liquid absorbing element in the atomizer are both non-detachable and when the first timing length reaches the preset first time length, it is determined that the replacement condition for the atomizer is satisfied.

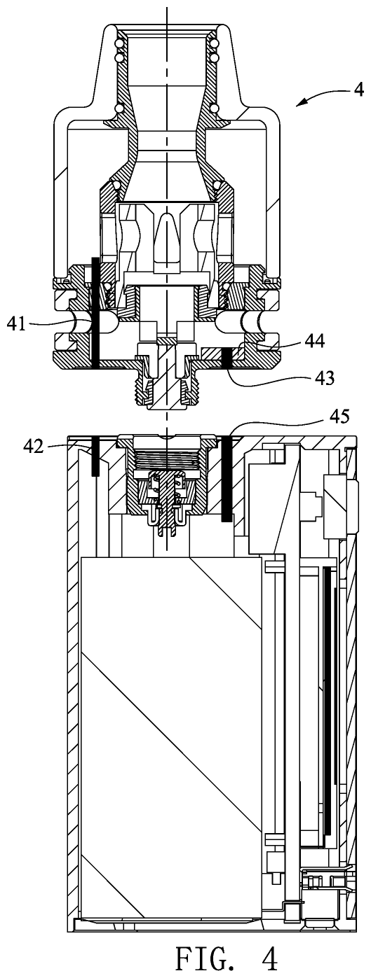

As shown in FIG. 3, step 120 can also be implemented by the following steps:

Step 123: obtaining a second timing length, wherein the second timing length is the length of time from the last time the atomizer was injected with liquid to the current time.

Step 124: when the second timing length reaches a preset second time length, obtaining the liquid level value of the liquid in the atomizer detected by the liquid level detector.

The preset second time length can be set by the system developer or the user. For example, the system developer can determine the shelf life of the liquid after being injected into the atomizer through experiments, and set the preset second time length according to the shelf life.

Step 125: when the liquid level value of the liquid is higher than the minimum liquid level value, determining that the replacement condition for the liquid is satisfied.

When T2 reaches the preset second time length, the most recently injected liquid remaining in the atomizer has deteriorated. At this time, it is necessary to determine whether the most recently injected liquid is used up. For details, see steps 124 and 125. If the liquid level value of the liquid in the atomizer obtained in step 124 is higher than the minimum liquid level value, it means that the most recently injected liquid has not been used up and has deteriorated and can no longer be used, and it is determined that the replacement condition for the liquid is satisfied; otherwise, it is considered that the most recently injected liquid is used up and there is no deteriorated liquid in the atomizer.

Step 130: when the replacement condition for the object to be replaced is satisfied, issuing a prompt information for prompting replacement of the object to be replaced.

For example, when the replacement condition for the cigarette liquid is satisfied, the prompt information for prompting the replacement of the cigarette liquid is issued; when the replacement condition for the atomizer is satisfied, the prompt information for prompting the replacement of the atomizer is issued.

Specifically, issuing the prompt information for prompting replacement of the object to be replaced can be implemented in the following ways:

First, a text prompt message for prompting the replacement of the object to be replaced is displayed on a display screen.

For example, when the replacement condition for the cigarette liquid is satisfied, a text prompt message of “the cigarette liquid in the atomizer has deteriorated, please do not use” is displayed on the display screen.

Second, a voice prompt message for prompting the replacement of the object to be replaced is broadcast.

For example, when the replacement condition for the cigarette liquid is satisfied, a voice prompt message of “the cigarette liquid in the atomizer has deteriorated, please do not use” is broadcast.

Third, a vibrator in the atomizer or in the electronic cigarette is controlled to vibrate.

It should be noted that, the embodiment of the present invention only schematically illustrates how to issue the prompt information for prompting replacement of the object to be replaced in the above three ways. In actual implementation, it can also be implemented by other ways, for example, the electronic cigarette is provided with an indicator light, and when the electronic cigarette determines that the replacement condition for the atomizer is satisfied, the indicator light is controlled to light up, which will not be repeated here.

Further, the way of issuing the prompt information for the object to be replaced can also be set by the user, that is, the method may further include:

receiving a setting instruction for setting the prompting way of issuing the prompt information for prompting replacement of the object to be replaced. The setting instruction may be an instruction for issuing the prompt information by vibration, an instruction for issuing the prompt information by ringing, an instruction for issuing the prompt information by text information, or an instruction for issuing the prompt information by indicator light.

Correspondingly, issuing the prompt information for prompting replacement of the object to be replaced includes:

issuing the prompt information according to the prompting way set by the setting instruction.

In summary, the method provided by the embodiment of the present invention starts timing when it is detected that the atomizer is filled with liquid; according to the timing information, it is determined whether the replacement condition for the object to be replaced is satisfied, wherein the object to be replaced includes at least one of the liquid and the atomizer; when the replacement condition for the object to be replaced is satisfied, a prompt information for prompting replacement of the object to be replaced is issued. It solves the problem in the related art that the judgment result by the user's subjective judgment on whether the atomizer or the components of the atomizer need to be replaced is prone to errors, and achieves the effect of timely prompting the user to replace the damaged components of the atomizer or the damaged atomizer.

When the atomizer is put in use for the first time, the liquid absorbing element in the atomizer needs to be wetted; if the liquid absorbing element is wetted, when the electronic cigarette controls the heating element to heat, dry burning easily occurs. In one example, in order to avoid dry burning, when receiving a trigger instruction for triggering the operation of the atomizer, it is determined whether the first timing length is less than a preset third time length; when the first timing length is less than the preset third time length, the atomizer is controlled not to operate according to the trigger instruction.

The preset third time length can be set by the developer or the user. For example, the developer can determine the length of time required for the liquid absorbing element (e.g., cotton core) to be completely wetted through experiments, and set the preset third time length according to this length of time.

Since the first timing length is the length of time that the liquid absorbing element (e.g., cotton core) is soaked. In the case where the first timing length is less than the preset third time length, the liquid absorbing element may have not be completely wetted. At this time, if the heating element is controlled to heat according to the trigger instruction, dry burning may easily occur. In order to avoid the occurrence of dry burning, in this embodiment, the heating element is controlled to heat according to the trigger instruction only when the first timing length is not less than the preset third time length.

In another example, in order to avoid dry burning, the electronic cigarette obtains the preset heating power when receiving the trigger instruction for triggering the operation of the atomizer; if the first timing length reaches a fourth time length corresponding to the heating power, the heating element is controlled, according to the trigger instruction, to heat at the heating power, otherwise, the atomizer is controlled not to operate according to the trigger instruction.

The heating power mentioned here is the heating power of the heating element. The heating power of the heating element can be set by the developer or by the user.

Optionally, the fourth time length for each heating power can be set by the developer. For example, the developer can determine the amount of liquid consumed at a heating power by the heating element in unit time through experiments, and using a preset fifth time length to multiply by the amount of liquid consumed in unit time, the amount of liquid required by the atomizer when working continuously for the preset fifth time length can be obtained, and the fourth time length is obtained by dividing this amount of liquid by the liquid absorption capacity of the heating element in unit time. If the first timing length reaches the fourth time length, it can ensure that the heating element, if it heats continuously, will not dry burning before reaching the fifth time length. Further, since the liquid absorption speed of the liquid absorbing element is generally higher than the speed of atomizing the liquid by the atomizer, dry burning will not occur even after the heating element continues to heat for the fifth time length.

As the working times of the atomizer increase and the cumulative working time increases, the carbon produced on the surface of the heating element also gradually increases, and the cotton core can no longer be used. That is, the atomizing head in the atomizer can no longer be used, and the atomizer or the atomizing head needs to be replaced.

In one example, the prompting method further includes: counting the working times of the atomizer; when the working times reach predetermined times, it is determined that the replacement condition for the atomizer is satisfied.

Specifically, the working times can be set by the system developer or by the user. For example, the developer can determine the working times of the atomizer when the atomizing head in the atomizer can no longer be used through experiments, and set the predetermined times to a value less than or equal to the working times.

Optionally, in the case where the atomizing head in the atomizer is detachable, when the working times of the atomizer reach the predetermined times, it can also be determined that the replacement condition for the atomizing head is satisfied, and the user is prompted to replace the atomizing head in the atomizer.

The following is divided into three cases to explain how to count the working times of the atomizer:

The first case: the electronic cigarette counts the working times of the atomizer.

The specific implementation may be: (1) when the electronic cigarette receives the trigger instruction for triggering the operation of the atomizer, the atomizer is controlled to operate and the number of working times of the atomizer is increased by 1; (2) when the state of the atomizer in the electronic cigarette changes from performing atomization to stopping atomization, the number of working times of the atomizer is increased by 1.

Optionally, in order to accurately count the working times of the atomizer, after the electronic cigarette replaces a new atomizer, the user can reset the working times of the atomizer on the electronic cigarette. For example, the electronic cigarette can be provided with a button to confirm the replacement of the atomizer. When the electronic cigarette detects that the button is continuously pressed for 5 seconds, the counted number of the working times of the atomizer is cleared to zero.

Optionally, in order to accurately count the working times of the atomizer, each atomizer is also provided with a unique device identifier, which may be a serial number, a device number, etc. The electronic cigarette can obtain the device identifier of the atomizer in the following ways, and update the working times of the atomizer according to the device identifier.

First, when an atomizer is installed to the body of an electronic cigarette, the data communication port of the MCU of the atomizer is electrically connected to the MCU of the electronic cigarette; the MCU of the atomizer sends its device identifier to the MCU of the electronic cigarette. The MCU of the electronic cigarette obtains the working times corresponding to the device identifier; and the working times of the atomizer are then updated according to the change of the working state of the atomizer.

Second, the electronic cigarette obtains the device identifier of the atomizer input by the user;

the MCU of the electronic cigarette obtains the working times corresponding to the device identifier; and the working times of the atomizer are then updated according to the change of the working state of the atomizer.

Optionally, the implementation that the MCU of the electronic cigarette obtains the working times corresponding to the device identifier may be: (1) the working times corresponding to the device identifier are obtained locally; if the working times corresponding to the device identifier are not obtained locally, then the working times of the atomizer will be determined to be zero, and the working times of the atomizer and the device identifier of the atomizer are stored accordingly; (2) the working times corresponding to the device identifier are obtained from the server, and the working times and the device identifier are stored accordingly; after the work times of the atomizer are updated, the updated work times and the device identifier of the atomizer are stored in the server.

The second case: the atomizer counts its working times.

The specific implementation may be: (1) when the MCU of the atomizer receives the trigger instruction for triggering the operation of the atomizer, the atomizer is controlled to operate and the number of working times of the atomizer is increased by 1; (2) when the MCU of the atomizer controls the atomizer to change from performing atomization to stopping atomization, the number of working times of the atomizer is increased by 1.

In another example, the prompting method further includes: counting the cumulative working time of the atomizer; when the cumulative working time reaches a preset fourth time length, it is determined that the replacement condition for the atomizer is satisfied.

Optionally, if the atomizing head in the atomizer is detachable, when the cumulative working time of the atomizer reaches the preset fourth time length, it can also be determined that the replacement condition for the atomizing head is satisfied, and the user is prompted to replace the atomizing head in the atomizer.

Optionally, in order to accurately count the cumulative working time of the atomizer, each atomizer is also provided with a unique device identifier, which may be a serial number, a device number, etc.

The electronic cigarette can obtain the device identifier of the atomizer and the realization manner of updating the working time of the atomizer according to the device identifier may refer to the previous description to obtain the device identifier of the atomizer and the realization manner of updating the working times of the atomizer according to the device identifier, which will not be repeated here.

As shown in FIG. 4, the present invention also provides an atomizer 4. The atomizer 4 is provided with a liquid level detector 41. The liquid level detector 41 may be any one of a resistance type, a microwave type, a laser type, or an ultrasonic type, a photoelectric type, a thermoelectric type, an inductive type, a capacitive type, an electromagnetic type, a piezoelectric type, an optical fiber type and a nuclear radiation type.

The liquid level detector 41 may be provided at the bottom of the atomizer 4 or at the top of the atomizer 4. In actual implementation, the developer sets the position of the liquid level detector 41 according to the type to which the liquid level detector 41 belongs. For example, in the case where the liquid level detector 41 is a magnetic floating ball liquid level gauge, the liquid level detector 41 includes a conduit through the detection part, the conduit needs to be vertically arranged in the liquid storage element of the atomizer 4, so that the detection part of the liquid level detector 41 floats up and down along the conduit as the liquid level in the liquid storage element changes.

Optionally, the body of the electronic cigarette is provided with a first contact 42 for the liquid level detector 41, and the first contact 42 is electrically connected to the power supply assembly 44 in the electronic cigarette. When the atomizer 4 is installed on the body of the electronic cigarette, the liquid level detector 41 is in contact with the first contact 42, and the power supply assembly 44 in the electronic cigarette can supply power to the liquid level detector 41 through the first contact 42.

Optionally, the atomizer 4 is further provided with at least one timer (not shown in the figure), and one of the at least one timer can be used to count the first timing length or the second timing length.

Optionally, the atomizer 4 further includes a processor 43, a power supply assembly 44, and a memory (not shown in the figure). At least one program instruction is stored in the memory; the processor 43 loads and executes the at least one program instruction to implement the prompting method according to any of the above embodiments.

The power supply assembly 44 may be a power supply device such as a coin battery, a lithium battery, a super capacitor, etc., and the power supply assembly 44 can supply power to components such as the processor 43, the liquid level detector 41, the at least one timer, etc. in the atomizer 4.

Further, in the case where the power supply assembly 44 is a super capacitor, the body of the electronic cigarette is also provided with a second contact 45 provided for the super capacitor, and the second contact 45 is electrically connected to the battery of the electronic cigarette. The super capacitor can supply power to the atomizer 4 such as the processor 43, the liquid level detector 41, the at least one timer, etc. through discharge; and when the atomizer 4 is installed to the body of the electronic cigarette, the battery in the electronic cigarette can charge the super capacitor.

An embodiment of the present invention also provides a prompting apparatus, which is a part of the electronic cigarette. The prompting apparatus includes a processor and a memory. At least one program instruction is stored in the memory; the processor implements the prompting method according to any of the foregoing embodiments by loading and executing the at least one program instruction. Further, the present invention also provides an electronic cigarette including the prompting apparatus.

Optionally, the electronic cigarette includes at least one timer, and one of the at least one timer can be used to count the first timing length or the second timing length.

An embodiment of the present invention also provides a computer storage medium that stores at least one program instruction, and the at least one program instruction is loaded and executed by a processor to implement the prompting method according to any of the foregoing embodiments.

The sequence numbers of the above embodiments of the present invention are for description only, and do not represent the advantages and disadvantages of the embodiments.

A person of ordinary skill in the art may understand that all or part of the steps for implementing the above-described embodiments may be completed by hardware, or may be completed by a program instructing related hardware. The program may be stored in a computer-readable storage medium. The mentioned storage medium may be a read-only memory, a magnetic disk or an optical disk, etc.

The above are only preferred embodiments of the present invention and are not intended to limit the present invention. Any modification, equivalent replacement, improvement, etc. within the principle of the present invention should be included in the protection scope of the present invention.

1. A prompting method, wherein the prompting method comprises:
starting timing when it is detected that liquid is injected into an atomizer;
determining whether a replacement condition for an object to be replaced is satisfied according to the timing information, wherein the object to be replaced comprises at least one of the liquid and the atomizer;
when the replacement condition for the object to be replaced is satisfied, issuing a prompt information for prompting replacement of the object to be replaced.

2. The prompting method according to claim 1, wherein determining whether a replacement condition for an object to be replaced is satisfied according to the timing information comprises:
obtaining a first timing length, wherein the first timing length is the length of time from the time when the atomizer is filled with liquid for the first time to the current time;
when the first timing length reaches a preset first time length, determining that the replacement condition for the atomizer is satisfied.

3. The prompting method according to claim 1, wherein determining whether a replacement condition for an object to be replaced is satisfied according to the timing information comprises:
obtaining a second timing length, wherein the second timing length is the length of time from the last time the atomizer was injected with liquid to the current time;
when the second timing length reaches a preset second time length, obtaining a liquid level value of the liquid in the atomizer detected by a liquid level detector;
when the liquid level value of the liquid is higher than a minimum liquid level value, determining that the replacement condition for the liquid is satisfied.

4. The prompting method according to claim 3, wherein starting timing when it is detected that liquid is injected into an atomizer comprises:
when the liquid level detector detects that the liquid level of the liquid in the atomizer increases, determining whether the atomizer is in the liquid filling state according to the posture of the atomizer;
when the atomizer is in the liquid filling state, starting timing to get the second timing length.

5. The prompting method according to claim 1, wherein the prompting method further comprises:
when receiving a trigger instruction for triggering the operation of the atomizer, determining whether a first timing length is less than a preset third time length, wherein the first timing length is the length of time from the time when the atomizer is filled with liquid for the first time to the current time;
when the first timing length is less than the preset third time length, controlling the atomizer not to operate according to the trigger instruction.

6. The prompting method according to claim 1, wherein the prompting method further comprises:
counting the number of working times or the cumulative working time of the atomizer;
when the number of working times reaches predetermined times, determining that the replacement condition for the atomizer is satisfied;
when the accumulated working time reaches a preset fourth time length, determining that the replacement condition for the atomizer is satisfied.

7. The prompting method according to claim 6, wherein counting the number of working times or the cumulative working time of the atomizer comprises:
obtaining the device identifier of the atomizer in the electronic cigarette;
updating the number of working times or the accumulated working time of the atomizer according to the device identifier and the change of the working state of the atomizer.

8. The prompting method according to claim 1, wherein the method further comprises:
receiving a setting instruction for setting the prompting way of issuing the prompt information for prompting replacement of the object to be replaced;
issuing the prompt information for prompting replacement of the object to be replaced comprises:
issuing the prompt information according to the prompting way set by the setting instruction.

9. A prompting apparatus, wherein the prompting apparatus comprises:
a memory and a processor;
at least one program instruction stored in the memory;
wherein the processor, by loading and executing the at least one program instruction, implements the prompting method according to claim 1.

10. (canceled)

11. An atomizer comprising the prompting apparatus according to claim 9.

12. The atomizer according to claim 11, wherein the atomizer comprises at least one of a timer and a power supply assembly.
